(19) United States
(12) Patent Application Publication
(10) Pub. No.: US 2013/0048112 A1
(43) Pub. Date: Feb. 28, 2013

(54) FLUID CONTROL VALVE

(71) Applicants: Kazuaki NEMOTO, Okazaki-city (JP); Tadao IKIHARA, Okazaki-city (JP)

(72) Inventors: Kazuaki NEMOTO, Okazaki-city (JP); Tadao IKIHARA, Okazaki-city (JP)

(73) Assignee: DENSO CORPORATION, Kariya-city (JP)

(21) Appl. No.: 13/593,710

(22) Filed: Aug. 24, 2012

(30) Foreign Application Priority Data
Aug. 31, 2011 (JP) 2011-188476

(51) Int. Cl. F16K 31/00

(52) U.S. Cl. 137/544

(57) ABSTRACT

A fluid control valve includes adjacent filters located adjacent to each other in an axis direction of a sleeve and extending in a circumference direction of the sleeve. Each of the filters has a collecting portion covering a corresponding fluid port, a combine section at which a first end portion and a second end portion are combined with each other in the circumference direction, and a connector portion connecting the collecting portion to the first end portion in the circumference direction. The collecting portion of one of the adjacent filters and the connector portion of the other of the adjacent filters are located adjacent with each other in the axis direction. The combine sections of the adjacent filters are located with each other in the axis direction.

### CROSS REFERENCE TO RELATED APPLICATION

This application is based on Japanese Patent Application No. 2011-188476 filed on Aug. 31, 2011, the disclosure of which is incorporated herein by reference in its entirety.

### TECHNICAL FIELD

The present disclosure relates to a fluid control valve.

### BACKGROUND

JP-B-4172211 (US 2003/0226593 A1) describes a fluid control valve controlling a flow of fluid. The fluid control valve is fitted into a hole of a heat receiver by inserting in an internal combustion engine. The heat receiver has a temperature increase by receiving heat. The fluid control valve includes a sleeve having plural fluid ports, and a valve body reciprocating in the sleeve in the axis direction to open/close the fluid ports.

An outer circumference face of the sleeve has plural annular groves respectively corresponding to the fluid ports and continuously extending in the circumference direction. The outer circumference face of the sleeve is fitted with the hole of the heat receiver. Filters extending in the circumference direction are respectively fitted with the annular grooves to filter the fluid flowing into the fluid ports, therefore the filter restricts a foreign matter from entering the sleeve.

Each of the filters has a hold portion, a first end portion, a second end portion, a first connector and a second connector. The hold portion holds a filter element that collects the foreign matter by covering the corresponding fluid port. The first end portion and the second end portion are combined with each other in the circumference direction at a combine section. The first connector connects the hold portion to the first end portion, and the second connector connects the hold portion to the second end portion. A fitting structure is defined between the first end portion and the second end portion, and is constructed by a convex and a recess fitted with each other.

A width of the first and second end portion in the axis direction of the sleeve is narrower than that of the hold portion. A width of the first and second connector in the axis direction is narrower than that of the first and second end portion and the hold portion. That is, each of the filters has the hold portion with the large width, the first and second connectors with the small width, and the first and second end portions with the middle width between the large width and the small width.

When adjacent filters are located adjacent with each other in the axis direction, the hold portion of one of the adjacent filters is located adjacent to the combine section of the first and second end portions of the other of the adjacent filters in the axis direction. If the width of the hold portion is required to be made larger to securely collect the foreign matter, an interval between the hold portion and the combine section becomes narrow in the axis direction. In this case, a sealing length of a border surface defined between the heat receiver and the sleeve becomes short in the axis direction between an annular groove to which the combine section is fitted and an annular groove to which the hold portion is fitted. As a result, the fluid may easily leak through the boarder surface, and the leak may affect the control accuracy of the fluid control valve.

If the width of the first and second end portion is made narrower, it is difficult to form the fitting structure between the first and second end portions, thereby lowering the combining strength. Further, the fitting structure between the first and second end portions may repeatedly expand and contract by having temperature variation due to heat transmitted from the heat receiver, thereby lowering the combining strength. If the combining strength is lowered, the filter element held by the hold portion may have position deviation relative to the fluid port, and the lowering in the filter function may affect the reciprocation movement of the valve body.

### SUMMARY

It is an object of the present disclosure to provide a fluid control valve with which the fluid control accuracy is maintained as high.

According to an example of the present disclosure, a fluid control valve that is to be inserted in a hole of a heat receiver to control a flow of fluid includes a sleeve, a valve body and plural filters. The sleeve has an outer circumference face that is fitted with the hole of the heat receiver and plural fluid ports through which the fluid passes. The fluid ports are arranged in an axis direction of the sleeve with interval. The outer circumference face has plural annular grooves continuously extending in a circumference direction of the sleeve and respectively corresponding to the plural fluid ports. The valve body reciprocates in the axis direction in the sleeve to open or close the fluid ports. The plural adjacent filters extending in the circumference direction to be fitted with the annular grooves respectively are located adjacent to each other in the axis direction. Each of the filters has a collecting portion, a first end portion, a second end portion, and a connector portion. The collecting portion collects a foreign object contained in the fluid by covering the corresponding fluid port. The first end portion and the second end portion are combined with each other in the circumference direction at a combine section by welding in a state where a face of the first end portion and a face of the second end portion are contact with each other in a radial direction of the sleeve. The connector portion connects the collecting portion and the first end portion with each other in the circumference direction. The collecting end of one of the adjacent filters and the connector portion of the other of the adjacent filters are located adjacent with each other in the axis direction. The combine sections of the adjacent filters are located with each other in the axis direction.

Accordingly, the fluid control valve can have high fluid control accuracy.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a schematic cross-sectional view illustrating a fluid control valve according to an embodiment;

FIG. 2 is a front view illustrating the fluid control valve;

FIG. 3 is a developed view illustrating filters of the fluid control valve;

FIG. 4 is a plan view illustrating the filter in the developed state; and

FIG. 5 is a plan view illustrating a filter of a fluid control valve according to a modification example in the developed state.

### DETAILED DESCRIPTION

### Embodiment

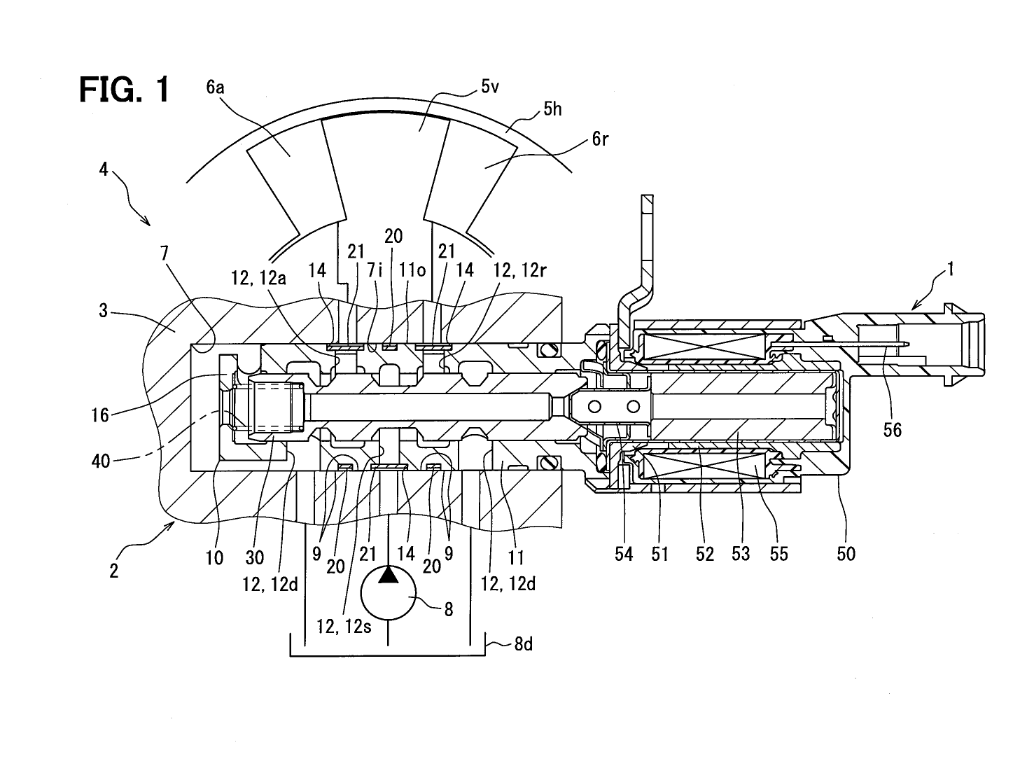

Hereafter, an embodiment will be described with reference to FIGS. 1-4. As shown in FIG. 1, a fluid control valve 1 is arranged in a heat receiver 3 such as cylinder head or cam cover of an internal combustion engine 2 which receives combustion heat. The fluid control valve 1 works as a part of a valve timing control device 4 which controls valve timing of an intake valve or an exhaust valve of the combustion engine 2.

The valve timing control device 4 defines an advance operating chamber 6a and a retard operating chamber 6r by dividing inside space of a housing 5h using a vane rotor 5v, and controls the valve timing by controlling a flow of working oil (hydraulic fluid) with respect to the operating chambers 6a and 6r. The fluid control valve 1 of the valve timing control device 4 controls the flow of hydraulic fluid with respect to each of the operating chambers 6a and 6r.

A basic configuration of the fluid control valve 1 will be described hereinafter. As shown in FIG. 1, the fluid control valve 1 has a sleeve 10, plural filters 20, a valve body 30, a return spring 40, and a solenoid 50.

The sleeve 10 has a based cylindrical shape, for example, molded using an aluminum die cast, and is coaxially inserted into an insertion hole 7 defined in the heat receiver 3. The hole 7 is a cylindrical blind hole. The sleeve 10 has a circumference wall 11, and an outer circumference surface 110 of the wall 11 is fitted with the hole 7. Five fluid ports 12 (12a, 12r, 12s, 12d) and three annular grooves 14 are defined to open in the outer circumference surface 11o.

The fluid ports 12 (12a, 12r, 12s, 12d) are arranged in an axis direction of the sleeve 10 with intervals, and penetrate the circumference wall 11 in a radial direction of the sleeve 10. Working oil flows into the advance operating chamber 6a through an advance fluid port 12a of the fluid ports 12. Working oil flows into the retard operating chamber 6r through a retard fluid port 12r of the fluid ports 12. Working oil supplied from an oil pump 8 flows through a supply fluid port 12s of the fluid ports 12. Working fluid to be discharged to a drain pan 8d of the oil pump 8 flows through a pair of drain fluid ports 12d of the fluid ports 12.

The three annular grooves 14 are located to correspond to the advance, retard, and supply fluid ports 12a, 12r, and 12s, respectively, into which working oil flows. The annular groove 14 continuously extends along the outer circumference surface 110 of the circumference wall 11 in a circumference direction of the sleeve 10 to have a ring shape. The fluid port 12a, 12r, 12s is opened in a bottom face of the corresponding annular groove 14. A border surface 9 is defined between the outer circumference surface 110 of the circumference wall 11 and an inner circumference surface 7i of the hole 7, and is located on both sides of the annular groove 14 in the axis direction.

Each of the filters 20 has a thin film shape, and is made of metal such as stainless steel. The filters 20 are respectively fitted with the annular grooves 14, therefore the number of the filters 20 is three in this embodiment. Each filter 20 extends inside of the corresponding annular groove 14 in the circumference direction. Both ends of the filter 20 in the circumference direction are combined with each other to have the ring belt shape that is fixed to the sleeve 10.

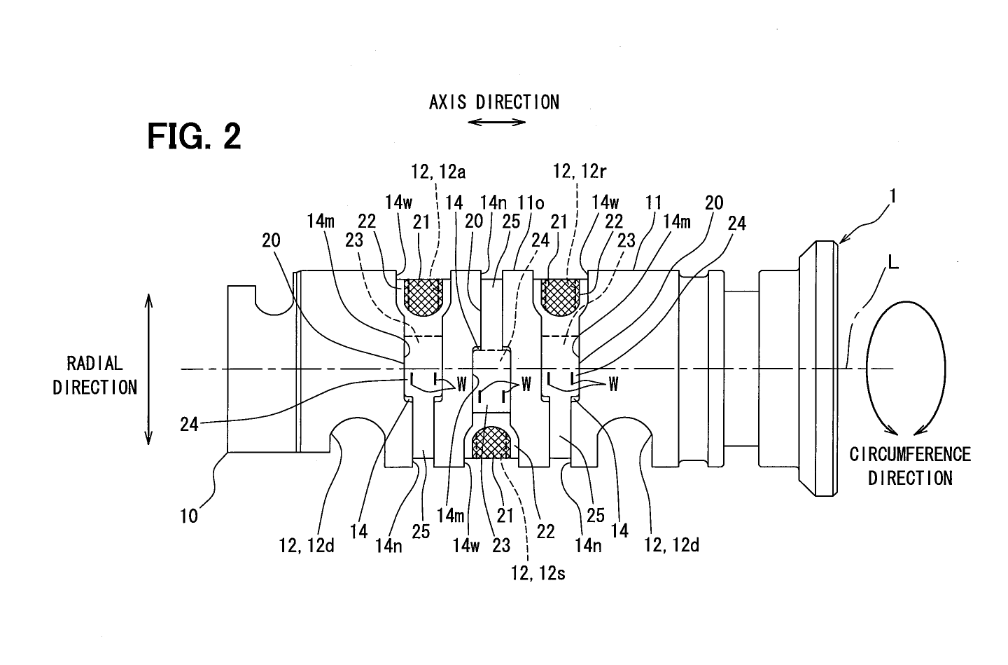

As shown in FIG. 2, each filter 20 has a mesh portion 21 at the intermediate position in the circumference direction. The mesh portion 21 has plural (many) pores penetrating the filter 20 in a thickness direction (corresponding to the radial direction of the sleeve 10), for example, by etching. The mesh portion 21 of the filter 20 opposes to the corresponding fluid port 12a, 12r, 12s in the radial direction (hereinafter referred as correspondence fluid port 12) at the corresponding axial position. The mesh portion 21 of each filter 20 collects foreign matter contained in working oil flowing into the correspondence fluid port 12, thereby filtering the working oil.

As shown in FIG. 1, the valve body 30 is a cylindrical spool made of metal, and is coaxially accommodated in the sleeve 10. The valve body 30 reciprocates in the axis direction, and opens/closes each fluid port 12. Specifically, the valve body 30 opens the advance fluid port 12a to the supply fluid port 12s, and opens the retard fluid port 12r to one of the drain fluid ports 12d, thereby advancing the valve timing. The valve body 30 opens the retard fluid port 12r to the supply fluid port 12s, and opens the advance fluid port 12a to the other drain fluid port 12d, thereby retarding the valve timing. Furthermore, the valve body 30 holds the valve timing by closing the advance fluid port 12a and the retard fluid port 12r relative to the other fluid ports 12.

The return spring 40 is a compression coil spring made with metal. The valve body 30 is arranged between the return spring 40 and the solenoid 50 in the axis direction. A first axial end of the return spring 40 is supported by a bottom wall 16 of the sleeve 10, and a second axial end of the return spring 40 opposite from the first axial end contacts the valve body 30. Thus, the return spring 40 generates the restoring force that presses the valve body 30 toward the solenoid 50 (rightward in FIG. 1).

The solenoid 50 has a stator core 51, a yoke core 52, a movable core 53, a movable shaft 54, a coil 55, and a terminal 56. The stator core 51 and the yoke core 52 have a cylindrical shape with the same axis, and are made of metal magnetic material. The stator core 51 and the yoke core 52 are spaced with each other in the axis direction. The movable core 53 has a cylindrical shape made of metal magnetic material, and is coaxially accommodated in the yoke core 52. The movable shaft 54 has a cylindrical shape made of metal, and is coaxially accommodated in the stator core 51. A first axial end of the movable shaft 54 is combined with the movable core 53, and a second axial end of the movable shaft 54 opposite from the first axial end contacts the valve body 30.

The coil 55 is made of metal wire wound around the outer circumference side of the stator core 51 and the yoke core 52. When electric power is supplied to the coil 55 through the metal terminal 56, the coil 55 generates magnetic flux passing through the cores 51, 52, 53. Due to the magnetic flux, the movable core 53 is magnetically attracted to the stator core 51, so that a force driving to press the valve body 30 to the return spring 40 (leftward in FIG. 1) is generated. Therefore, the valve body 30 is driven to reciprocate in both-way in the axis direction based on the balance between the driving force generated by the solenoid 50 and the restoring force generated by the return spring 40.

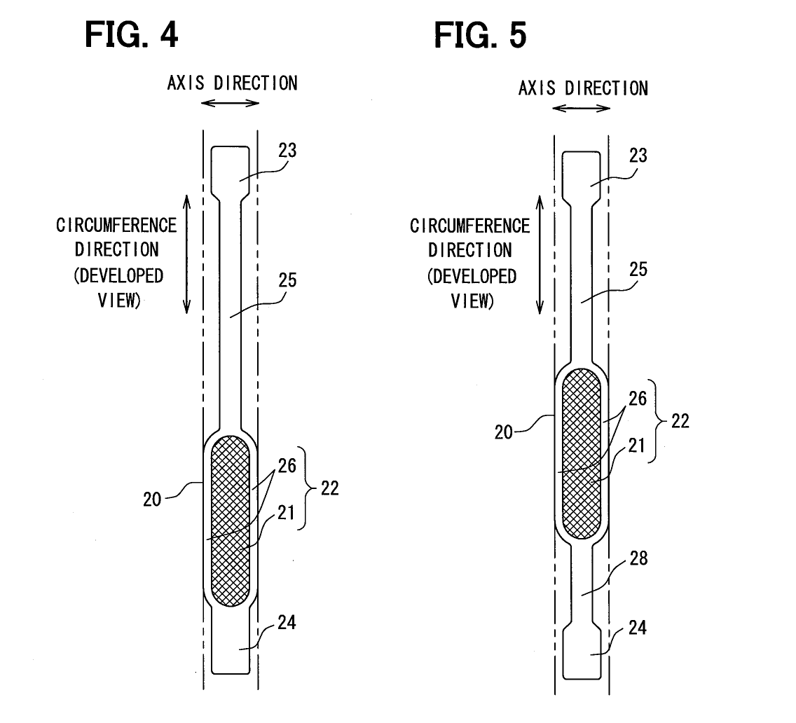

As shown in FIG. 4, each of the filters 20 has a collecting portion 22, a first end portion 23, a second end portion 24, and a connector portion 25. The collecting portion 22 defines the mesh portion 21. The first end portion 23 and the second end portion 24 are combined with each other in the circumference direction, as shown in FIG. 2. The connector portion 25 connects the collecting portion 22 to the first end portion 23.

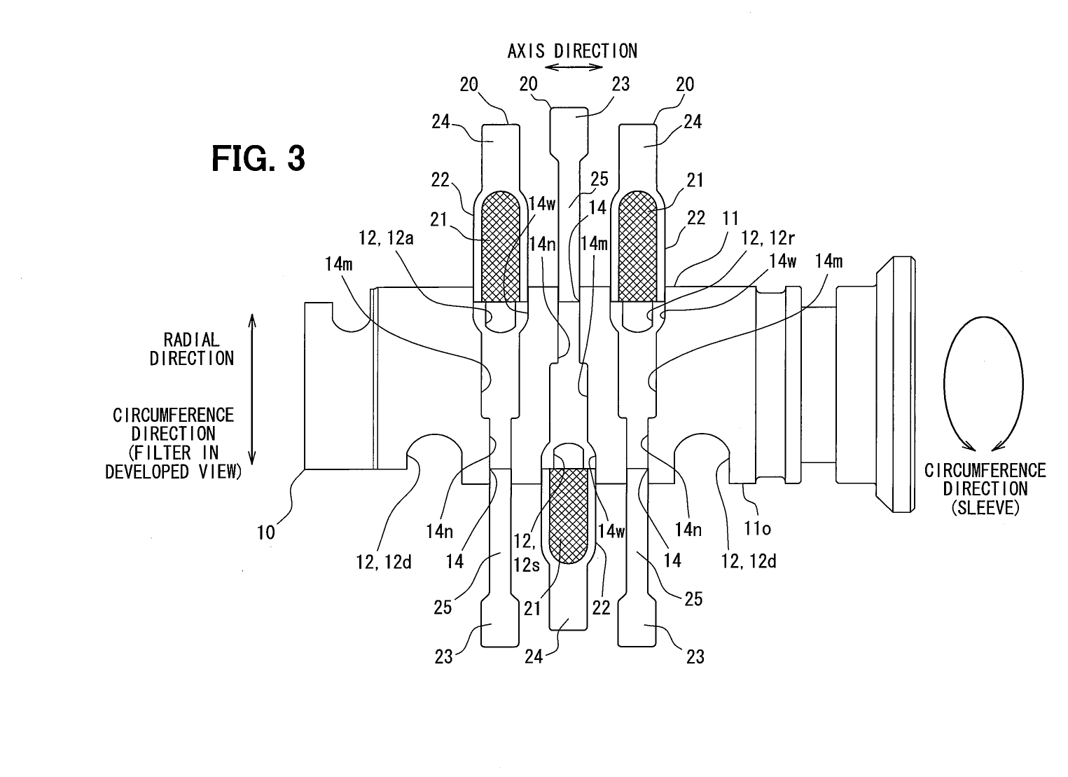

Here, FIGS. 3 and 4 illustrate developed view of the filter 20 in the state before the first end portion 23 and the second end portion 24 are combined with each other. In addition, the circumference direction, the axis direction, and the radial direction are defined in FIG. 2 based on the sleeve, and these directions are used also for the filter 20.

As shown in FIG. 4, in each of the filters 20, the collecting portion 22 has a fitting edge 26 that does not have the pores, and the fitting edge 26 is located on both sides of the mesh portion 21 in the axis direction. As shown in FIG. 3, each of the annular grooves 14 has a wide part 14w, a narrow part 14n and a middle part 14m. The width of the groove 14 in the axis direction becomes narrower in order of the wide part 14w, the middle part 14m and the narrow part 14n.

The fitting edge 26 is fitted with the width part 14w of the annular groove 14. A width of the mesh portion 21 in the axis direction is set to be equal to or larger than a width of the corresponding fluid port 12 in the axis direction. Therefore, all of the corresponding fluid port 12 is covered with the mesh portion 21 of the filter 20, so as to improve the function of collecting a foreign matter. That is, the whole width of the collecting portion 22 (including the fitting edge 26) in the axis direction is secured to be larger than an open width of the correspondence fluid port 12 in the axis direction.

Moreover, as shown in FIGS. 2 and 3, the positions of the collecting portions 22 are offset by shifting in the circumference direction between the filters 20 located adjacent with each other in the axis direction. That is, the collecting portions 22 do not overlap in the axis direction between the adjacent filters 20. In contrast, the positions of the collecting portions 22 are approximately the same in the circumference direction between the filter 20 covering the advance fluid port 12a and the filter 20 covering the retard fluid port 12r, which are located on both sides of the supply fluid port 12s in the axis direction.

In each of the filters 20 of FIGS. 2-4, the first and second end portions 23, 24 located on the both ends of the collecting portion 22 in the circumference direction have approximately the same width in the axis direction that is narrower than that of the collecting portion 22 in the axis direction. The first end portion 23 extends out from the connector portion 25 in a direction opposite from the collecting portion 22 in the circumference direction, and is fitted with the middle part 14m of the annular groove 14. The middle part 14m has a width in the axis direction that is smaller than that of the wide part 14w and that is larger than that of the narrow part 14n of the annular groove 14. The second end portion 24 extends out from the collecting portion 22 in a direction opposite from the connector portion 25 in the circumference direction, and is fitted with the middle part 14m of the annular groove 14.

As shown in FIG. 2, a surface of the first end portion 23 and a surface of the second end portion 24 are contact with each other in the radial direction with the surface contact state, inside of the middle part 14m of the annular groove 14, and are combined with each other by welding to have a combine section. The first end portion 23 and the second end portion 24 are combined with each other at the combine section, and the combine sections of the filters 20 are located adjacent with each other along an imaginary line L extending in the axis direction.

Here, in this embodiment, the combine sections of the filters 20 are slightly shifted from each other in the circumference direction between the adjacent filters 20. In addition, the welding is conducted to two weld places W spaced from each other in the axis direction for each of the filters 20, for example, using a laser device.

Moreover, the position relationship between the first end portion 23 and the second end portion 24 in the radial direction is made opposite from each other between the adjacent filters 20. Specifically, when the first end portion 23 is located radially outer side than the second end portion 24 in one of the adjacent filters 20, the first end portion 23 is located radially inner side than the second end portion 24 in the other of the adjacent filters 20.

Therefore, whole of the first end portion 23 is combined with a part of the second end portion 24, that is located on the radially outer side, with the surface contact state in each of the filters 20 covering the advance fluid port 12a and the retard fluid port 12r. In contrast, whole of the first end portion 23 is combined with a part of the second end portion 24, that is located on the radially inner side, with the surface contact state in the filter 20 covering the supply fluid port 12s.

As shown in FIG. 3, a direction extending from the first end portion 23 through the connector portion 25 and the collecting portion 22 to the second end portion 24 in the circumference direction is opposite between the adjacent filters 20. In contrast, the direction extending from the first end portion 23 through the connector portion 25 and the collecting portion 22 to the second end portion 24 in the circumference direction is the same between the filters 20 covering the advance fluid port 12a and the retard fluid port 12r.

The width of the connector portion 25 of each filter 20 in the axis direction is set narrower than that of the collecting portion 22 and the first and second end portions 23, 24, and the connector portion 25 is fitted with the narrow part 14n of the annular groove 14. In each of the filters 20, the connector portion 25 extends out from the collecting portion 22 to the first end portion 23 in the circumference direction, and opposes to the collecting portion 22 in the radial direction. Therefore, as shown in FIG. 2, the collecting portion 22 of each filter 20 is located adjacent with the connector portion 25 of the adjacent filter 20 in the axis direction.

Operation and advantage of the fluid control valve 1 will be described hereinafter. The filter 20 filters hydraulic fluid flowing into the correspondence fluid port 12 at each axial position, and restricts a foreign matter from entering the sleeve 10. Thus, the valve body 30 can work normally without being affected by the foreign matter.

In each filter 20, the width of the first and the second end portion 23, 24 is narrower than that of the collecting portion 22. Furthermore, the width of the connector portion 25 is narrower than that of the end portions 23, 24 and the collecting portion 22. That is, the width in the axis direction is made narrower in order of the collecting portion 22, the end portions 23, 24, and the connector portion 25.

The collecting portion 22 is secured to have the large width for collecting foreign matters, and is located adjacent to the connector portion 25 of the adjacent filter 20 in the axis direction. Therefore, the interval between the collecting portion 22 and the connector portion 25 of the adjacent filter 20 in the axis direction can be extended by making the connector portion 25 narrower as possible to meet the required strength for the connecting function.

Thus, the border surface 9 can be secured to have the long sealing length in the axis direction between the annular grooves 14, in which one of the grooves 14 is fitted with the collecting portion 22 and the other groove 14 is fitted with the connector portion 25 of the adjacent filter 20. The border surface 9 is defined by the fitting structure between the outer circumference surface 110 of the sleeve 10 and the hole 7 of the heat receiver 3. Accordingly, working oil can be restricting from leaking from the border surface 9 defined between the sleeve 10 and the heat receiver 3, therefore the control accuracy of the fluid control valve 1 can be maintained as high.

According to the embodiment, the end portions 23 and 24 are combined to have the surface contact state in the radial direction at the combine section by welding, and the combine sections of the adjacent filters 20 are located adjacent with each other in the axis direction. Thereby, the interval between the combine sections can be extended in the axis direction by making the end portion 23, 24 narrower as possible to meet the required width for the welding. Therefore, the sealing length of the border surface 9 defined between the sleeve 10 and the hole 7 of the heat receiver 3 can be secured to be long in the axis direction between the annular grooves 14 to which the end portions 23, 24 of the adjacent filters 20 are fitted, while the combine strength of the end portions 23, 24 is secured.

Moreover, even if the end portions 23 and 24 repeatedly expand and contract due to a temperature variation generated by heat transmitted from the heat receiver 3, the combine strength of the end portions 23 and 24 is difficult to be lowered. Accordingly, working oil can be restricting from leaking from the border surface 9 defined between the sleeve 10 and the hole 7 of the heat receiver 3, therefore the control accuracy of the fluid control valve 1 can be maintained as high. Further, the filtering performance of the filter 20 can be maintained as high by keeping the combine strength of the end portions 23 and 24, therefore the valve body 30 can work normally.

According to the embodiment, the position relationship between the collecting portion 22 and the connector portion 25 in the circumference direction becomes opposite between the adjacent filters 20, because the direction extending to the second end portion 24 from the first end portion 23 in the circumference direction is opposite between the adjacent filters 20. Therefore, the collecting portion 22 having the large width and the connector portion 25 having the small width are located adjacent with each other in the axis direction between the adjacent filters 20.

Thus, it is easy to secure a large interval between the collecting portion 22 and the connector portion 25 in the axis direction. Therefore, the sealing length of the border surface 9 defined between the sleeve 10 and the hole 7 of the heat receiver 3 can be secured to be long in the axis direction between the annular grooves 14 to which the collecting portion 22 and the connector portion 25 located adjacent with each other are fitted. Accordingly, working oil can be restricting from leaking from the border surface 9 defined between the sleeve 10 and the hole 7 of the heat receiver 3 with more reliability.

In addition, the first end portion 23 contacts the second end portion 24 from the radially inner side to have the surface contact in one of the adjacent filters 20, and the first end portion 23 contacts the second end portion 24 from the radially outer side to have the surface contact in the other of the adjacent filters 20. As shown in FIG. 3 illustrating the developed view, the direction going to the second end portion 24 from the first end portion 23 in the circumference direction is made opposite between the adjacent filters 20.

Therefore, the welding can be performed at once or sequentially to the combine sections of the end portions 23 and 24 after the filters 20 are respectively fitted with the corresponding annular grooves 14 by winding around the sleeve 10 at once, because the combine sections are located adjacent with each other in the axis direction. Accordingly, the productivity of the fluid control valve 1 can be raised.

Furthermore, as shown in FIG. 2, the connector portion 25 and the collecting portion 22 oppose with each other in the radial direction, in each of the filters 20. The collecting portion 22 having the large width is made to certainly be located adjacent to the connector portion 25 having the small width in the axis direction between the adjacent filters 20. Therefore, a large interval can be secured between the collecting portion 22 and the connector portion 25 in the axis direction.

Thus, the sealing length of the border surface 9 defined between the sleeve 10 and the hole 7 of the heat receiver 3 can be secured to be long in the axis direction between the annular grooves 14 to which the collecting portion 22 and the connector portion 25 are fitted. Accordingly, working oil can be restricting from leaking from the border surface 9 with more reliability.

### Modifications

The present disclosure should not be limited to the embodiment, but may be implemented in other ways without departing from the sprit of the present disclosure.

The number of the filters 20 is three in the above embodiment. Alternatively, the number of the filters 20 may be two or more than four to correspond to the number of the fluid ports 12 and the annular grooves 14. Moreover, as a modification example shown in FIG. 5, the filter 20 may further include another connecting portion 28 other than the connector portion 25. The connecting portion 28 connects the collecting portion 22 to the second end portion 24, while the connector portion 25 connects the collecting portion 22 to the first end portion 23. Furthermore, the mesh portion 21 of the collecting portion 22 may be made of another material (for example, filter medium) different from the material of the fitting edge 26, while the mesh portion 21 is defined by etching the same material in the above embodiment.

The direction going to the second end portion 24 from the first end portion 23 in the circumference direction may be set in the same direction between the adjacent filters 20 having the combine sections adjacent with each other in the axis direction. Moreover, the position relationship between the end portions 23 and 24 in the radial direction may be made the same between the adjacent filters 20 having the combine sections adjacent with each other in the axis direction. Furthermore, the combine section of the first and second end portions 23, 24 may be configured to oppose to the collecting portion 22 in the radial direction, in each of the filters 20.

The fluid control valve 1 may be applied to other apparatus other than the valve timing control device 4.

Such changes and modifications are to be understood as being within the scope of the present disclosure as defined by the appended claims.

What is claimed is:

1. A fluid control valve that is to be inserted in a hole of a heat receiver to control a flow of fluid, the fluid control valve comprising:
a sleeve having an outer circumference face that is fitted with the hole of the heat receiver and a plurality of fluid ports through which the fluid passes, the fluid ports are arranged in an axis direction of the sleeve with interval, the outer circumference face having a plurality of annular grooves continuously extending in a circumference direction of the sleeve and respectively corresponding to the plurality of fluid ports;
a valve body reciprocating in the axis direction in the sleeve to open or close the fluid ports; and
a plurality of adjacent filters extending in the circumference direction to be fitted with the annular grooves respectively and located adjacent to each other in the axis direction, wherein
each of the filters has
a collecting portion that collects a foreign object contained in the fluid by covering the corresponding fluid port,
a first end portion and a second end portion combined with each other in the circumference direction at a combine section by welding in a state where a face of the first end portion and a face of the second end portion are contact with each other in a radial direction of the sleeve, and
a connector portion connecting the collecting portion and the first end portion with each other in the circumference direction,
the collecting portion of one of the adjacent filters and the connector portion of the other of the adjacent filters are located adjacent with each other in the axis direction, and
the combine sections of the adjacent filters are located with each other in the axis direction.

2. The fluid control valve according to claim 1, wherein
the second end portion extends from the collecting portion in the circumference direction, and
a direction extending from the first end portion to the second end portion in the circumference direction is opposite between the adjacent filters having the combine sections located adjacent with each other in the axis direction.

3. The fluid control valve according to claim 1, wherein
the first end portion and the second end portion have a position relationship in the radial direction in each of the adjacent filters, and
the position relationship is opposite between the adjacent filters having the combine sections located adjacent with each other in the axis direction.

4. The fluid control valve according to claim 1, wherein
the connector portion extends from the collecting portion in the circumference direction and opposes the collecting portion in the radial direction, in each of the adjacent filters.

5. The fluid control valve according to claim 1, wherein
the collecting portion has a first width in the axis direction,
the first end portion and the second end portion have a second width narrower than the first width of the collecting portion in the axis direction, and
the connector portion has a third width narrower than the first width of the collecting portion and the second width of the first end portion and the second end portion in the axis direction.
